(19) United States
(12) Patent Application Publication
(10) Pub. No.: US 2009/0188679 A1
(43) Pub. Date: Jul. 30, 2009

(54) Fitting Plate for an Animal Shod Hoof

(76) Inventor: Joseph Vaillant, Cluses Cedex (FR)

Correspondence Address: MARJAMA MULDOON BLASIAK & SULLIVAN LLP, 250 SOUTH CLINTON STREET, SUITE 300, SYRACUSE, NY, 13202, US

(21) Appl. No.: 11/922,286

(22) PCT Filed: Jun. 12, 2006
(86) PCT No.: PCT/FR2006/001346

§ 371 Date: Feb. 25, 2009

(30) Foreign Application Priority Data
Jun. 17, 2005 (FR) 0506250

(51) Int. Cl. A01L 7/02

(52) U.S. Cl. 168/28

(57) ABSTRACT

The fitting plate (1) fixable between a shoe (2) and the hoof (3) of animal leg (4) is made of at least one type of synthetic material whose surface covers the hoof surface is characterised in that the surface (10) comprises two areas (11, 12) exhibiting different hardness, i.e., the area (12) corresponds to the ares called heel area (12a, 12b) of the hoof and the other area (11) corresponds to the hoof remaining area and exhibits a hardness greater than that of the heel area (12a, 12b).

This invention concerns a fitting plate for an animal's iron-shod foot, and more particularly for a horse hoof, intended notably for equestrian sport.

Iron-shod animals used in sport events have their feet shod with metallic or synthetic protections including a separator plate placed between the shoe and the hoof and one or several products moulded on-site, filling the space between the plantar arch (called sole) and the underside of the plate forming cushions in order to isolate this area from any foreign body intrusion.

There is a variety of separator plate (called fitting plate). Said plates are all used to protect the plantar face of the foot and to absorb shocks that could damage the horse limb.

The most common fitting plates are made of only one material across their surface.

Other fitting plates are forming a multi-layered sandwich of various material, each layer covering the whole surface.

Another type of improved fitting plate, in particular marketed under the brandname “Shocktamer©,” is realized to form a bi-layer made of the same grade elastomer including a circuit normally provided to channel and evacuate the energy resulting from the global shock each time the shod foot contact the ground.

To this day, no fitting plates proposed as such take into account the pressure distribution actually endured over the entire surface each time the shod foot contacts the ground, nor the areas actually solicited at the time of foot propulsion from the ground.

This invention intends to remedy the above mentioned inconveniences, and thus provides a fitting plate that efficiently distributes pressures across the entire surface of the animal's shod foot and in whatever way the foot contacts the ground, and which solicits the various areas of the foot efficiently during its propulsion phase.

To this end, the object of the invention is a fitting plate, intended to be attached between an iron and the hoof of an animal's foot, of the type realized in at least one synthetic material whose surface covers the foot surface, characterized in that its surface consists of two areas of different hardness, a first area corresponding to the “heels” of the foot and the other to the rest of the foot surface, opposite and of greater hardness than the heel area.

Other advantages and characteristics will become more obvious when reading the detailed description hereafter of an example of the invention embodiment in reference to the figures.

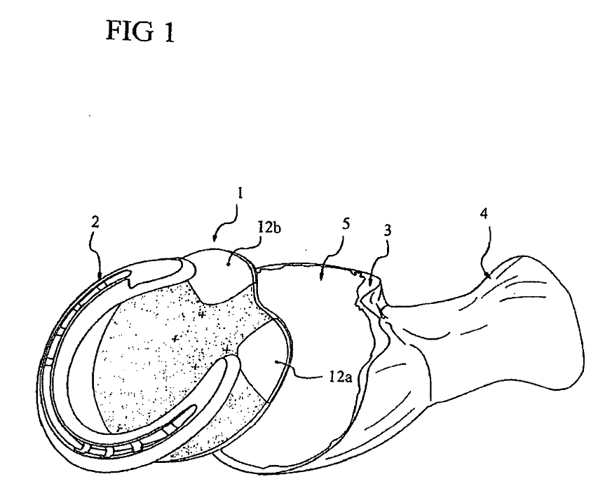

FIG. 1 is a view in exploded perspective of a horse shod foot with a fitting plate according to the invention and realized according to a first mode.

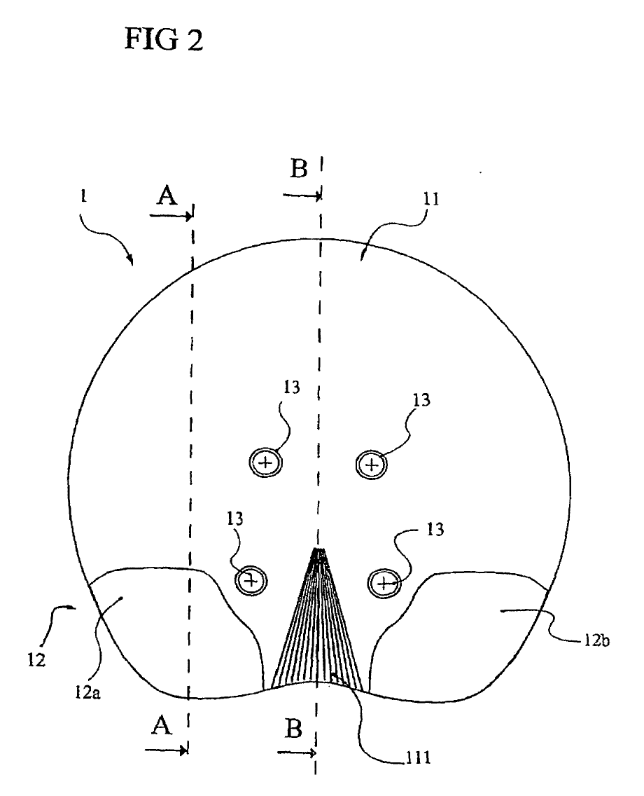

FIG. 2 is a top view of a fitting plate according to the invention realized according to a second mode.

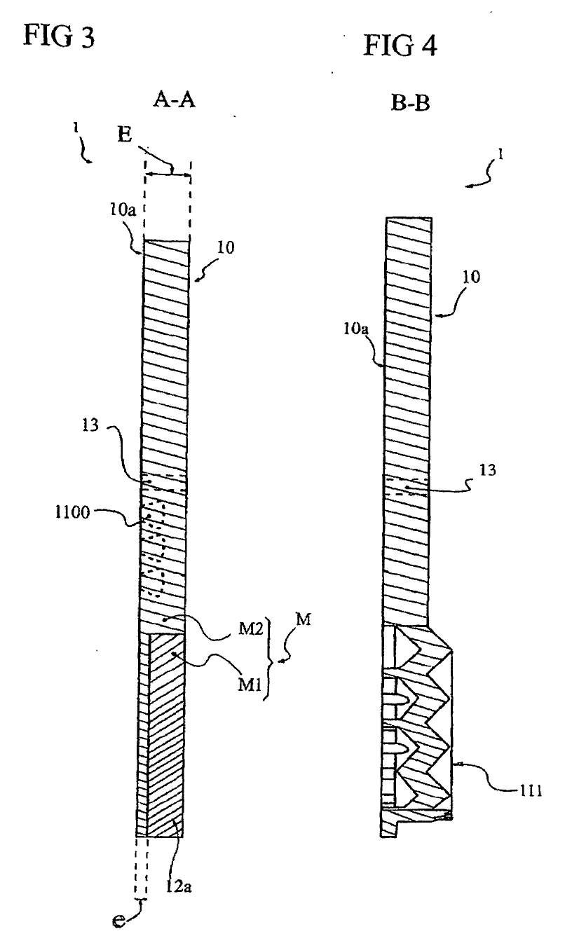

FIG. 3 is a cross-section of the fitting plate according to FIG. 2 across A-A.

FIG. 4 is a cross-section of the fitting plate according to FIG. 2 across B-B.

The fitting plate according to the invention holds general reference (1), and is intended to be set between an iron (2) and hoof(3) of an animal foot (4), said plate (1) is made of at least one synthetic material whose surface covers the foot surface, as represented in FIG. 1.

According to the invention, surface (10) of plate (1) includes two areas (11, 12) of different hardness, one of the areas, a first area corresponding to the so-called “heel” area (12a, 12b) of the foot, and the other area so-called second area (11) corresponding to the rest of the foot surface and of higher hardness than the heel area.

It will be noted that first area (12), i.e. the heels, is in fact made of two primary areas (12a, 12b) located in the back, and laterally on each sides of the general plan of symmetry.

In the illustrated and preferred form of embodiment of the invention, the hardness difference between the two areas (11, 12) is at least 10%.

In other words, the fitting plate is built in bi-material intended to fulfill definite functions in distinct areas of the foot, such as:

The heel area, i.e. the first area (12a, 12b) is realized in a material which hardness and consistence can absorb the shocks from the foot when contacting the ground.

The front area of the foot, i.e. the second area (11), is realized in a synthetic material which hardness is at least 10% greater than the heel material, and its consistency adapted to the dynamics, can restore part of the energy to participate in boosting the propulsion move.

The difference in hardness between the two materials can be of 25%, for example.

As an example, the material hardness of the first area (12a, 12b) can for example range from 35 Shore D to 55 Shore D, while the material hardness of the second area (11) can for example range from 38.5 Shore D to 70 Shore D, knowing that the material hardness difference between the two areas is at least 10%.

As represented in FIG. 3, the plate is made of a material (M) of two different grades (A1,A2) bi-injected or moulded from casting between them. The material chosen is advantageously a single material for both areas, and is for example an elastomer of the polyurethane (PU) or polyester amides (PESA) type.

More precisely, the moulding from casting is realized so that the lowest grade material is either overlapped by the strongest grade in the heel area (12a, 12b) (FIG. 3).

As illustrated, the overlap thickness (e) is equal to a maximum of ⅓ of the thickness (E) of the plate main layer (10).

According to the preferred form of embodiment, the second area (11) of the surface distinct from that of the heels (12) is advantageously realized in transparent material in order to be able to visualize the flow of material underneath (10a) said plate, attached between it and the foot plantar arch (4), and provided to constitute a shoeing cushion (5) capable of having a material grade in different areas.

The second area (11) distinct from the heel area (12) is pierced with at least one filling pre-hole (13) for material(s) constituting a cushion (5). The material chosen for the form of embodiment in FIG. 1 is silicone, for example. Filling is preferably realized by injection, so that the pre-hole (13) closes back once filling is completed, thanks to the flexibility of the material.

The underside face (10a) of one of the heels (12a, 12b) distinct area, intended to be facing the plantar arch, includes at least one blind hole (1100) in undercut in order to facilitate the mechanical engagement of a shoeing cushion (5).

In the illustrated and preferred form of embodiment, plate (1) includes a plurality of groves (111) made between the two parts (12a, 12b) of heel area (12), in order to facilitate the spacing between these when the shod foot hits the ground. As illustrated in FIG. 4, groves (111) form a protuberance on the opposite side of the plantar arch, the height of lo this protuberance being advantageously provided not to extend further than shod-iron (2).

Fitting plate (1) according to the invention, by providing distinct areas of different hardness over one layer confers distinct cushion and propulsion effects according to the concerned areas: Cushioning is a lot more significant in the heel area at the time the animal shod foot contacts the ground, while propulsion is a lot more dynamic in area (11) at the level of the front of the foot during its propulsion phase.

The fitting plate somehow accompanies with the natural movement of the animal shod foot, and contributes to it, in addition to its protective basic function, a cushioning and a dynamic propulsion optimized according the areas solicited.

Of course, the invention is not limited to the described forms of embodiment and is represented as examples, but it also includes all technical equivalents as well as their combinations. Therefore the man of the art will be able to easily choose all type of material or material mixtures in order to obtain these distinct areas with differential hardness.

1. A fitting plate provided to be attachable between a shoe and hoof of an animal foot made of at least one type of synthetic material whose surface covers said hoof, characterized in that surface of said fitting plate comprises two areas exhibiting different hardness, one of said areas corresponding to heel area of the hoof, and the other of the areas corresponding to a remaining surface of said hoof and of hardness greater than that of the heel area.

2. A fitting plate according to claim 1, characterized in that the hardness difference between the two areas is at least 10%.

3. A fitting plate according to claim 2, characterized in that the hardness difference between the two areas is at least 25%.

4. A fitting plate according to claim 2, characterized in that the hardness of the material of the first area ranges between 35 Shore D and 55 Shore D, while the hardness of the material of the second area ranges between 38.5 Shore D and 70 Shore D.

5. A fitting plate according to claim 1, characterized in that it is constituted of only one material of two different hardness grades

6. A fitting plate according to claim 1, characterized in that the material is an elastomer of polyurethane (PU) or polyester amides (PESA) type.

7. A fitting plate according to claim 5, characterized in that the molding from casting is realized in such a way that the material with the lowest grade is overlapped by the higher grade in the heel area.

8. A fitting plate according to claim 7, characterized in that the overlap thickness (e) is at most equal to ⅓ of the thickness (E) of the main layer of the plate.

9. A fitting plate according to claim 1, characterized in that area distinct from that of the heel area is made in a transparent material in order to visualize the flow of material below said plate, attached between the plate underside and foot plantar arch, and provided to constitute a shoeing cushion capable of having a material grade in different areas.

10. A fitting plate according to claim 9, characterized in that the area distinct from the heel areas is pierced by at least one filling pre-hole for material(s) constituting a shoeing cushion.

11. A fitting plate according to claim 1, characterized in that the plate underside face intended to be facing plantar arch, includes at least one blind hole in undercut in order to facilitate the mechanical engaging of a shoeing cushion.

12. A fitting plate according to claim 1, characterized in that the plate includes a plurality of convergent groves realized between two parts of the heel area, in order to favor the spacing between these during the impacts on the ground of the shod foot.

13. A fitting plate according to claim 3, characterized in that the hardness of the material of the first area ranges between 35 Shore D and 55 Shore D, while the hardness of the material of the second area ranges between 38.5 Shore D and 70 Shore D.

14. A fitting plate according to claim 6, characterized in that the molding from casting is realized in such a way that the material with the lowest grade is overlapped by the higher grade in the heel area.
